(19) United States
(12) Patent Application Publication
(10) Pub. No.: US 2009/0227138 A1
(43) Pub. Date: Sep. 10, 2009

(54) Electrical connector adapter for connecting with two rows of cables

(75) Inventors: Biao-Bing Lv, Kunshan (CN); Ming Zhang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/381,054

(22) Filed: Mar. 5, 2009

(30) Foreign Application Priority Data
Mar. 5, 2008 (CN) 200820032481.4

(51) Int. Cl. H01R 13/58

(52) U.S. Cl. 439/466

(57) ABSTRACT

An electrical connector connected with cables defines an insulating housing and a plurality of contacts retained in the insulating housing. Each of the contacts defines a connecting beam for connecting with said cable. Said contacts are arranged at two opposite sides of the insulating housing. The cables could extend out of the electrical connector in two rows form two opposite sides of insulating housing, so that the dimension of the electrical connector is decreased.

### BACKGROUND OF THE INVENTION

1. Field of the invention

The present invention relates to an electrical connector, and particularly to an electrical connector connecting with two rows of cables.

2. Description of Related Art

In most of the electrical devices nowadays, an electrical connector assembly which comprises a plug connector and a receptacle connector is used to provide an electrical connection between cables and a printed circuit board (PCB), such as that disclosed in Japanese Patent Publication No. 2006-344524. The plug connector has a plurality of first contacts connecting said cables, and the receptacle connector is mating with the plug connector and mounted on the PCB. The plug connector has a plurality of contacts, which have one row of contacting portions arranged in one side of the insulating housing and a row of soldering portions extending to a rear portion of the housing to solder with the cable.

When the number of cables is to increase along with the tendency of high-speed transmission of cables nowadays, a longitudinal dimension of the plug connector will be larger, however it will occupy more space on PCB. It is necessary to provide a new electrical connector to solve the problems above.

### SUMMARY OF THE INVENTION

Accordingly, an object of the present invention is to provide an electrical connector designed to connecting with two rows of cable.

In order to achieve above-mentioned object, an electrical connector for connecting a plurality of cables is provided which comprises an insulating housing defining a receiving cavity and a bottom wall, a plurality of contacts arranged in two rows, each contact comprising a connecting beam; two rows of cables comprising conductors connecting with the connecting beams of the contacts; the connecting beams of the two rows of the contacts extend in opposite directions and the two rows of cables extend in directions in which the connecting beams extend.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled, perspective view of an electrical connector assembly according to an preferred embodiment of the present invention, showing a plug connector mated with a receptacle connector;

FIG. 2 is an perspective view of the electrical connector assembly, showing the plug connector and the receptacle connector before mating in accordance with FIG. 1;

FIG. 3 is an exploded, perspective view of the receptacle connector in accordance with FIG. 2;

FIG. 4 is an exploded, perspective view of the plug connector in accordance with FIG. 2;

FIG. 5 is a cross-section view of the electrical connector assembly taken along lines 5-5 in FIG. 2; and,

FIG. 6 is a cross-section view of the electrical connector assembly taken along lines 6-6 in FIG. 1.

### DETAILED DESCRIPTION OF THE INVENTION

The present invention shall be discussed hereinafter in terms of a preferred embodiment illustrated in the accompanying drawings. In the following description, numerous specific details are set forth in order for the reader hereof to gain a thorough understanding of the present invention. It will be obvious, however, to those skilled in the art that certain well-know elements may not be shown in detail in order to unnecessarily obscure the present invention.

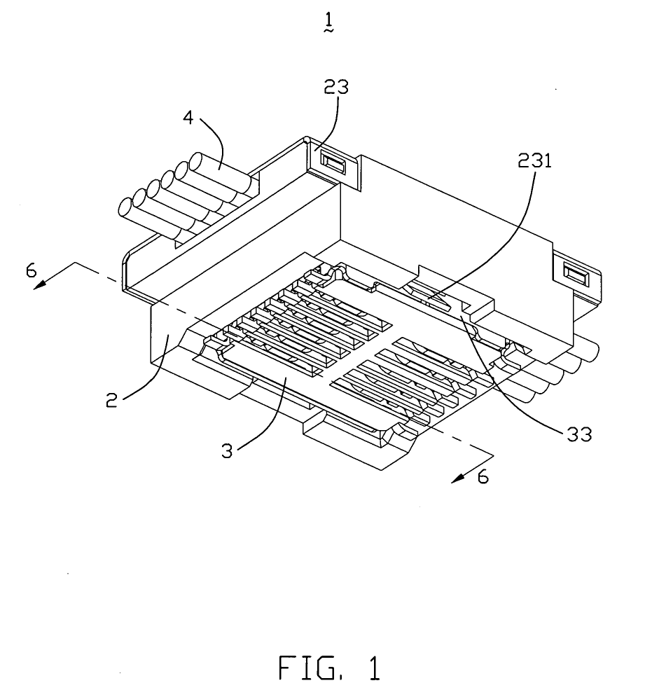

Referring to FIG. 1, an electrical connector assembly 1 in accordance with the present invention is provided with a plug connector 2 connecting with a plurality of cables 4 and a receptacle connector 3 mounted on a PCB (not shown).

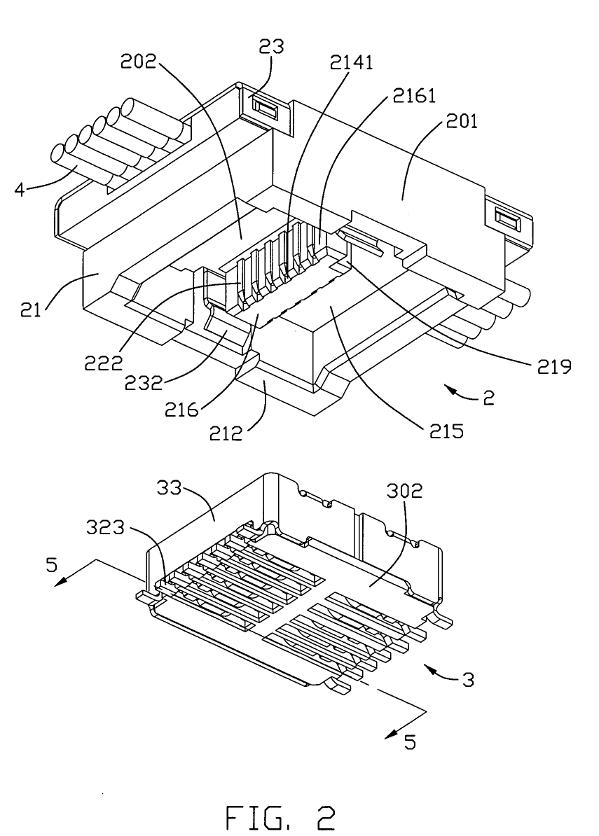

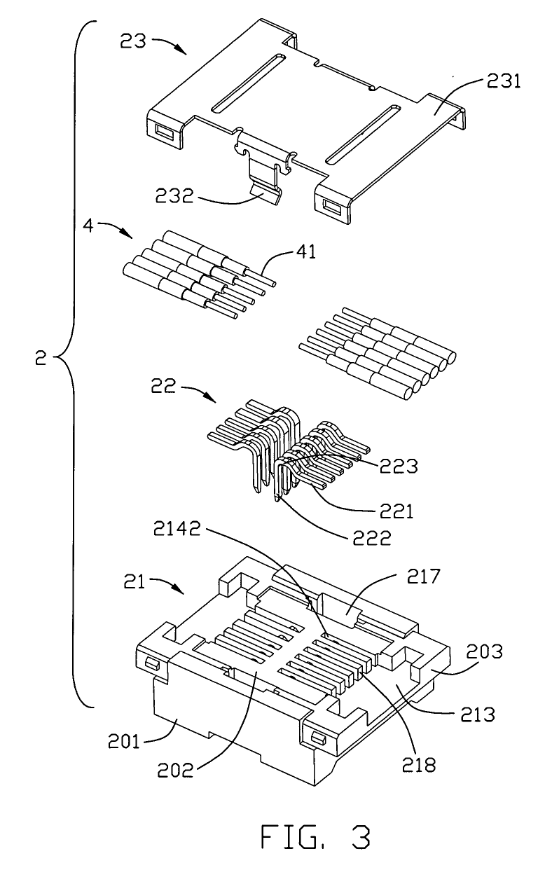

Referring to FIG. 2 and FIG. 3, the plug connector 2 includes a first insulating housing 21, a plurality of first contacts 22 retained in the first insulating housing 21 and a first shell 23 covered on the first insulating housing 21. The first insulating housing 21 defines therein a rectangular receiving cavity 215 surrounded by four peripheral walls 201 and a bottom wall 202, the receiving cavity 215 opens an exterior through a mating face 212. A tongue portion 216 protrudes into the receiving cavity 215 from an inner side of the bottom wall 202 and extends in a first direction, with a cutout 219 formed at one tip end thereof for leading the receptacle connector 3 in a right way.

A plurality of first passageways 2141 are arranged on the two side surface 2161 of the tongue portion 216 along the first direction and each extending along the protruding direction of the tongue portion 216. The second passageways 2142 partitioned by rib 218, are arranged on the bottom wall 202 in the first direction and each runs in a second direction perpendicular to the first direction until to two opposite ends of the first insulating housing 21. The first insulating housing 21 further extends two flanges 203 respectively at two opposite ends thereof, and the flanges 203 defines cable-receiving grooves 213 communicating with the second passageways 2142 and an end exterior, on the bottom wall 202 thereof.

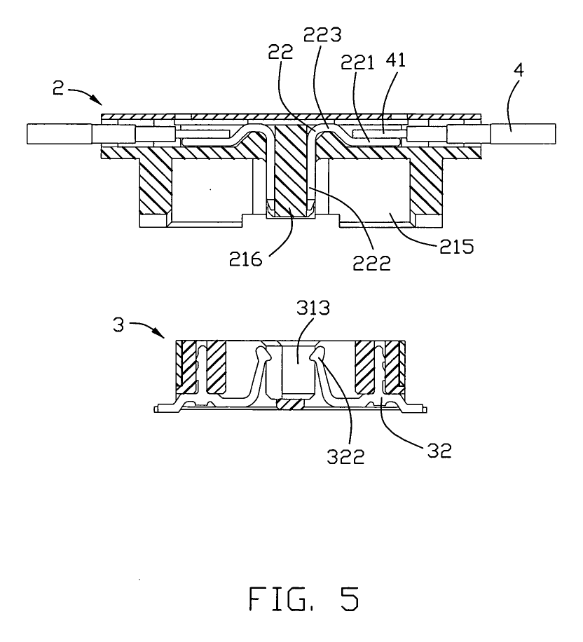

As shown in FIG. 3, each first contact 22 has a connecting beam 221, a contacting beam 222 perpendicular to the connecting beam 221 and a jointing portion 223 therebetween for jointing the connecting beam 221 and the contacting beam 222. The contacting beams 222 are received in the first passageways 2141 for electrically connecting with said receptacle connector 3 and the connecting beams 221 are received in the second passageways 2142. As shown in FIG. 5, the connecting beams 221 are hidden in the second passageway 2142 by the ribs 218. The jointing portion 223 is bended upwardly to be higher than the connecting beam 221 for preventing solder from flowing to the receiving cavity 215. The first contacts 22 are arranged with two rows and the connecting beams 221 thereof extend in opposite directions.

The receiving cavity 215 defines a pair of holes 217 at inners of two opposite side wall of the peripheral walls 201 of the first insulating housing 21, which run through the bottom wall 202 downwardly. The first shell 23 includes a horizontal plate 231 downwardly mounted onto the bottom face of bottom wall 202 of said first insulating housing 21, and a pair of spring beams 232 extending vertically and downwardly from two sides of the plate 231 respectively and received in said holes 217. The spring beams 232 protrude into the receiving cavity 215.

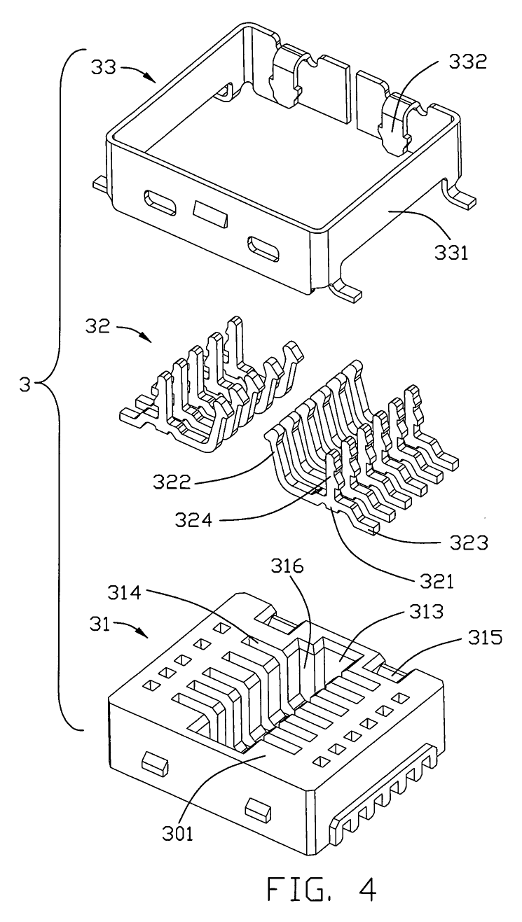

Referring to FIG. 2 and FIG. 4, the receptacle connector 3 includes a second insulating housing 31, a plurality of second contacts 32 retained in the second insulating housing 31 and a second shell 33 surrounding and shielding the second insulating housing 31. Said second insulating housing 31 defines a receiving groove 313 surrounded by four sidewalls 301 and a bottom wall 302 thereof, which extends in the first direction for receiving said tongue portion 216 of the plug connector 2. A protruding portion 316 are formed at one corner of the receiving groove for engaging with said cutout 219 of the tongue portion 216. Two rows of passageways 314 are formed in two opposite sidewalls 301 and arranged along the first direction, and a pair of mounting holes 315 are downwardly recessed from one sidewall 301. Each passageway 314 downwardly runs through the second insulating housing 312.

Each second contact 32 received in the passageways 314 has a base portion 321, a contacting portion 322 extending upwardly from one end of the base portion 321 into the receiving groove 313, a soldering tail 323 extending from another end of the base portion 321 out of the second insulating housing 31, and a fixing portion 324 extending from the middle of the base portion 321 upwardly for fixing the second contact 32 into the second insulating housing 31.

The second shell 33 has a plate portion 331 bended to be quadrate and a pair of locking barbs 332 extending from a top edge of the plate portion 311 downwardly to be retained in said mounting holes 315 in order to fix the second shell 33 around the second insulating housing 31 and provide an EMI (Electronic Magetic Interference) protection.

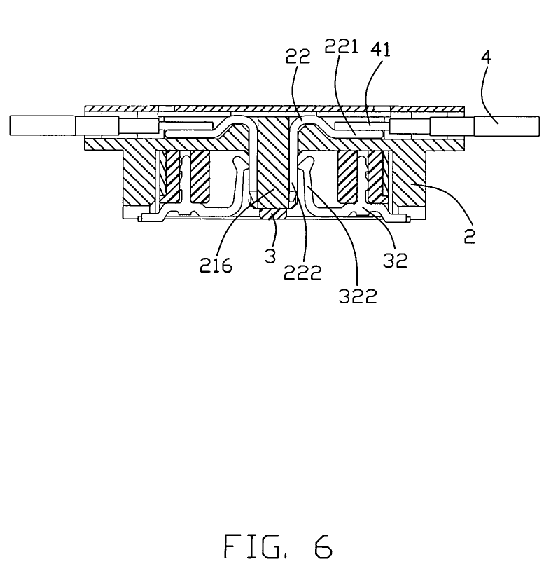

Referring to FIG. 3 and FIG. 5, two rows of the cables 4 are downwardly assembled into the plug connector 2 oppositely before the first shell 23 are assembled and retained in the cable-receiving grooves 213 and extend in directions in which the connecting portions 221 of the first contacts 22 extend. Each cable 4 has an inner conductor 41 inserted in the second passageways 2142 and soldered with said connecting beam 221 of the first contact 22 for an electrical connection. Then the first shell 23 is assembled to the bottom face of the first insulating housing 21 for shielding the cables 4 and the connecting beam 221. Said two rows of the cables 4 extend in two opposite directions. Referring to FIG. 6, the plug connector 2 mates with said receptacle connector 3 to provide an electrical connection between the cables 4 and the PCB(not shown) by the electrical connection between said contacting portions 322 and contacting beams 222. Referring to FIG. 6, said two spring beams 232 of the first shell 23 fasten the second shell 33 to provide an EMI protection.

As described above, the first contacts 22 of the plug connector 2 are divided into two rows with said connecting beams 221 arranged in opposite ends of the first insulating housing 21, while the cables 4 could be divided into two rows as well for connecting with said first contacts 22 and extend in opposite directions respectively. In this way, the longitudinal dimension of the plug connector 2 could be reduced even if the number of said cables 4 increase, which absolutely reduces the whole dimension of the electrical connector 1 too.

However, while the preferred embodiment of the invention has been shown and described, it will apparent to those skilled in the art that changes and modifications may be made therein without departing from the spirit of the invention, the scope of which is defined by the appended claims.

What is claimed is:

1. An electrical connector assembly comprising:
an electrical connector comprising:
an insulating housing defining a receiving cavity and a bottom wall,
a plurality of contacts arranged in two rows, each contact comprising a connecting beam;
two rows of cables comprising conductors connecting with the connecting beams of the contacts; wherein
the connecting beams of the two rows of contacts extend in opposite directions and the two rows of cables extend in directions in which the connecting beams extend.

2. The electrical connector assembly as claimed in claim 1, wherein said bottom wall has a plurality of passageways running to two opposite ends of the insulating housing, and the connecting beams of the contacts are received in the passageways.

3. The electrical connector assembly as claimed in claim 2, wherein the insulating housing has a plurality of ribs partitioning the passageways, and the connecting beams are hidden in the passageways by the ribs.

4. The electrical connector assembly as claimed in claim 3, wherein said cables are inserted in the passageways and connect with the connecting beams in the passageways.

5. The electrical connector assembly as claimed in claim 4, wherein said contact has a contacting beam perpendicular to the connecting beam.

6. The electrical connector assembly as claimed in claim 5, wherein said contact has a jointing portion between the contacting beam and the connecting beam for jointing them together, and the jointing portion is bent upwardly to be higher than the connecting beam.

7. The electrical connector assembly as claimed in claim 6, wherein a tongue portion protrudes into the receiving cavity from an inner side of the bottom wall and has a plurality of passageways arranged on the two side surfaces thereof, and the contacting beams are received in the passageways of the tongue portion.

8. The electrical connector assembly as claimed in claim 7, wherein said electrical connector has a shell covered on the insulating housing and shielding the connecting beam.

9. The electrical connector assembly as claimed in claim 8, further comprising a receptacle connector including a receiving room for mating with the tongue portion of said electrical connector.

10. The electrical connector assembly as claimed in claim 9, wherein said tongue portion has a cutout at one tip end thereof and the receptacle connector has a protruding portion protruding into the receiving room for engaging with said cutout.

11. The electrical connector assembly as claimed in claim 10, wherein said receptacle connector includes a second insulating housing and a shell bent to shield the second insulating housing.

12. An electrical connector comprising:
an insulating housing defining a receiving cavity surrounded by a bottom wall and sidewalls, the bottom wall defining two rows of passageways thereon;
a plurality of contacts each comprising a contacting beam exposed to the cavity and a connecting beam; wherein
said plurality of contacts are divided into two rows, the connecting beam of the two rows are received within the passageways and extend in opposite directions.

13. The electrical connector as claimed in claim 12, wherein the passageways run to two opposite ends of the insulating housing.

14. The electrical connector as claimed in claim 13, wherein the insulating housing has a plurality of ribs partitioning the passageways, and the connecting beams are hidden in the passageways by the ribs.

15. The electrical connector as claimed in claim 14, wherein a tongue portion protrudes in the receiving cavity.

16. The electrical connector as claimed in claim 15, further comprising a shell covered on the insulating housing and shielding the connecting beam.

17. An electrical connector assembly comprising:
a first connector including a first insulative housing defining a mating tongue exposed in a first mating cavity, two rows of first contacts respectively disposed in the housing with first contact sections positioned upon two opposite surfaces of the mating tongue; and
a second connector including a second insulative housing received in the first mating cavity and defining a second mating cavity receiving said mating tongue therein, two rows of second contacts respectively disposed in the housing by two sides of the second mating cavity with second contact sections engaged with the corresponding first contact sections; wherein
the second contacts are mounted to a printed circuit board while the first contacts are connected with corresponding two rows of cables extending in two opposite directions.

18. The electrical connector assembly as claimed in claim 17, wherein a row direction defined by said two rows of first contacts is perpendicular to said two opposite directions.

19. The electrical connector assembly as claimed in claim 18, wherein said second connector further include a metallic shell enclosing the second housing circumferentially and received in said first mating cavity.

20. The electrical connector assembly as claimed in claim 19, wherein said first connector further includes a metallic shell covering a face of the first housing opposite to said first mating cavity.
